(19) United States
(12) Patent Application Publication
(10) Pub. No.: US 2026/0340558 A1
(43) Pub. Date: Oct. 29, 2026

(54) SYSTEM AND METHOD FOR PERFORMING IMPACT ANALYSIS ASSOCIATED WITH A SERVICE OUTAGE OF A SERVICE

(71) Applicant: Honeywell International Inc., Charlotte, NC (US)

(72) Inventors: Kartikeyan Bollapalli, Bangalore (IN); Ankit Singh, Apex, NC (US); Sarath Kumar Ganesan, Bangalore (IN)

(21) Appl. No.: 19/188,033

(22) Filed: Apr. 24, 2025

(51) Int. Cl. G06Q 10/0637; G06F 16/3329

(52) U.S. Cl. CPC G06Q 10/06375; G06F 16/33295

(57) ABSTRACT

A system and method for performing impact analysis associated with a service outage of a service is disclosed. The system comprises a storage and a processor coupled to the storage. The processor is configured to receive a service outage alert message associated with the service. Further, the processor is configured to obtain a service description document associated with the service and one or more historic case reports associated with the service outage from one or more data storages. Further, the processor is configured to generate using an AI model, an impact analysis report comprising information about a business impact of the service outage based on the service description document, the one or more historic case reports, and at least one prompt which is provided as an input to the AI model. The at least one prompt comprises at least one instruction to perform the business impact analysis associated with the service outage based on the service description document and the one or more historic case reports. Further, the processor is configured to provide the impact analysis report for displaying on a display of a user device.

### TECHNICAL FIELD OF THE INVENTION

The present subject matter pertains to impact analysis and, more specifically, to systems and methods for assessing the impact associated with service outages affecting one or more services within a client facility.

### BACKGROUND OF THE INVENTION

When customers experience infrastructure-related issues such as service outages or performance degradation, a support ticket is generated within the system and assigned to a technical support engineer for resolution. The engineer utilizes monitoring and diagnostic tools, including Grafana, AppDynamics, and log analytics, to assess the health of the affected services within the cluster. While these tools assist in identifying potential causes of service disruptions, certain cases involve complex, large-scale failures where the estimated resolution time remains uncertain. In such scenarios, C-suite executives from the customer's organization and the service provider must conduct a comprehensive impact assessment to determine the business and financial consequences of the outage. This evaluation is essential for devising mitigation strategies that minimize operational disruptions, financial losses, and reputational risks. However, the existing process lacks an efficient mechanism for rapidly analyzing the business impact using Site Reliability Engineering (SRE) trackers, system logs, and historical data. As a result, decision-makers often face challenges in obtaining a clear, data-driven understanding of how an outage may affect business operations.

The ability to respond effectively to critical infrastructure incidents is crucial for protecting customer interests and ensuring financial stability. Without a structured method for assessing and communicating the impact of service disruptions, organizations risk delays in response, misinformed decision-making, and potential financial liabilities. The existing methods require extensive manual effort from SRE, Engineering, and Offering teams to extract relevant insights and convey the severity of incidents to stakeholders. This manual process becomes particularly inefficient during high-priority incidents, where rapid resolution is essential. Additionally, the reliance on fragmented data sources introduces risks of inaccuracy and incompleteness, further complicating the validation of claims regarding business losses.

Therefore, for addressing limitations of existing method it is required to have an integrated, automated approach that enables the client to efficiently assess, quantify, and communicate the business impact of service outages in their facility and/or environment in real time.

### SUMMARY OF THE INVENTION

The present subject matter discloses methods and system for performing real time impact analysis associated with a service outage of a service. The methods and systems correlate infrastructural anomalies with business and technical workflow using large language model (LLM) to perform real time impact analysis.

In an embodiment, a method of performing impact analysis associated with a service outage of a service is disclosed. The method includes receiving a service outage alert message associated with the service. Further, the method includes obtaining a service description document associated with the service and one or more historic case reports associated with the service outage from one or more data storages. Further, the method includes generating using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports. The method further includes providing the impact analysis report for displaying on a display of a user device.

In some embodiments, the generating includes providing the service description document, the one or more historic case reports, and the at least one prompt as an input to the AI model. Further, the generating includes receiving the impact analysis report comprising information about the business impact of the service outage as an output from the AI model.

In some embodiments, the method includes displaying a plurality of prompts on the display of the user device, wherein each of the plurality of prompts comprises a corresponding business impact analysis instruction. Further, the method receiving a user input indicative of a selection of the at least one prompt from the plurality of prompts. Further, the method includes providing the at least one prompt as an input to the AI model for performing the business impact analysis associated with the service outage based on the service description document and the one or more historic case reports.

In some embodiments, the obtaining includes transmitting, by a processor, a search request to a contextual search database, wherein the search request comprises a service identifier of the service and information associated with the service outage. Further, the obtaining includes receiving the service description document and the one or more historic case reports from the contextual search database.

In some embodiments, the method includes receiving the search request at the contextual search database. Further, the method includes querying, by the contextual search database, a first data storage based on the service identifier of the service, wherein the first storage is a documents database comprising a plurality of service description documents corresponding to a plurality of services. Further, the method includes receiving the service description document associated with the service from the documents database, in response to the querying. Further, the method includes transmitting the service description document to the processor.

In some embodiments, the method includes receiving the search request at the contextual search database. Further, the method includes querying, by the contextual search database, a second data storage based on the search request, wherein the second data storage is a historical reports database comprising a plurality of historic case reports corresponding to a plurality of service outages of a plurality of services. Further, the method includes receiving the one or more historic case reports associated with the service outage from the historical reports database, in response to the querying. Further, the method includes transmitting the one or more historic case reports to the processor.

In some embodiments, the method includes storing the impact analysis report in a historical reports database which comprises a plurality of historic case reports corresponding to a plurality of service outages of a plurality of services.

In an embodiment, a system for performing impact analysis associated with a service outage of a service is provided. The system comprises processor configured to receive a service outage alert message associated with the service. The processor is further configured to obtain a service description document associated with the service and one or more historic case reports associated with the service outage from one or more data storages. Further, the processor is configured to generate using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports. The processor is also configured to provide the impact analysis report for displaying on a display of a user device.

In yet another embodiment, a computer-readable medium having computer-executable instructions stored thereon is disclosed. The computer-executable instructions, when executed by a processor, cause the processor to receive a service outage alert message associated with the service. Further, the computer-executable instructions further cause the processor to obtain a service description document associated with the service and one or more historic case reports associated with the service outage from one or more data storages. Furthermore, the computer-executable instructions cause the processor to generate using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports. Furthermore, the computer-executable instructions cause the processor to provide the impact analysis report for displaying on a display of a user device.

The systems and methods described above provide real time impact assessment using LLM. The proposed solution enables users to respond to service interruptions immediately and plan mitigation strategies to reduce any associated risks.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

FIG. 1 illustrates an environment implementing a system for performing impact analysis associated with a service outage of a service in a client environment, according to one or more embodiments of the present disclosure.

FIG. 2 illustrates block diagram of a system for performing impact analysis associated with a service outage of a service in a client environment, according to one or more embodiments of the present disclosure.

FIG. 3 illustrates a flowchart of a method for performing impact analysis associated with a service outage of a service, according to one or more embodiments of the present disclosure.

FIG. 4 is a flowchart illustrating a method for generating an impact analysis report associated with a service outage of a service, according to one or more embodiments of the present disclosure.

FIG. 5 is a flowchart illustrating a method for performing impact analysis associated with a service outage of a service, according to one or more embodiments of the present disclosure.

FIG. 6 is a flowchart illustrating a method for performing impact analysis associated with a service outage of a service, according to one or more embodiments of the present disclosure.

FIG. 7 is a flowchart illustrating a method for obtaining a service description document associated with a service while performing impact analysis, according to one or more embodiments of the present disclosure.

FIG. 8 is a flowchart illustrating a method for performing impact analysis associated with a service outage of a service, according to one or more embodiments of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

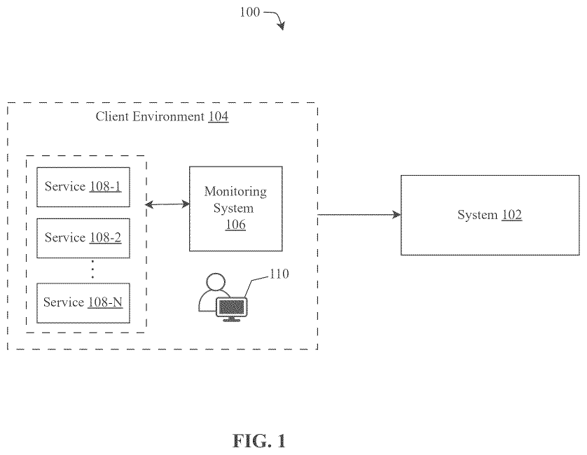

FIG. 1 illustrates an environment 100 implementing a system 102 for performing impact analysis associated with a service outage of a service in a client environment 104, according to one or more embodiments of the present disclosure. In an embodiment, the client environment 104 may be a manufacturing plant, an industry, a production house, etc. The client environment 104 may further include a monitoring system 106, a plurality of services 108-1 . . . 108-N, referred to as service(s) 108 in the detailed description, and a user device 110.

In an embodiment, the services 108 may refer to the various operational, technical, and functional components that ensure the execution of tasks within the client environment 104. In an example, the service(s) may include, but are not limited to machine operations, data management, network communication, energy distribution, process automation, security protocols, etc. In an example, the service(s) 108 may be classified into various categories based on their roles in the client environment 104 such as infrastructure and operations services, data and IT services, process and workflow automation services. In an example, the infrastructure and operations services may further include equipment and machine control services that are responsible for the automation and operation of machinery, production lines, and industrial systems, energy management services to ensures efficient use of electricity and power sources, etc. In an example, the data and IT services may include network and communication services to handle internet connectivity, data transfer, and cloud operations, file storage and data management services to store critical files, production data, and system logs. In an example, the process and workflow automation services may include predictive maintenance services to anticipate machine failures and schedules proactive repairs and quality control and compliance services to ensures that final products meet predefined standards.

Further, in an example, the service(s) 108 may depend on the nature of the client environment 104. For example, in case of client environment 104 being a manufacturing plant, the services associated with said manufacturing plant may include but not limited to, machine control system for controlling and monitoring machines in the factory, production line system to ensures conveyor belts and robotic arms are working correctly, equipment maintenance system to predicts when a machine will fail, energy management system to tracks electricity usage, etc.

In an embodiment, the monitoring system 106 may be understood as user equipment including computing devices, sensors, etc., and the monitoring system 106 may be responsible for overseeing the service(s) 108 of the client environment 104. In an embodiment, the monitoring system 106 may oversee the service(s) 108 by performing one or more functions which include but not limited to data collection, anomaly detection and alerts, performance analysis, etc. In an example, in the monitoring system 106, the data collection may be performed using sensors, software logs, to gather real-time information on service performance. For example, in a manufacturing plant, machine sensors collect temperature, pressure, and vibration data. Further, in an example, the performance analysis may include comparing real-time data against predefined thresholds to detect irregularities. For example, if energy consumption exceeds normal levels, the monitoring system 106 may identify it as an anomaly. Further, in an example, the anomaly detection and alerts may include identifying service disruptions, slowdowns, or potential failures. For example, if a conveyor belt speed decreases abnormally, an alert is triggered. In an embodiment, the monitoring system 106 may continuously evaluate/monitor the operational status of the service(s) 108 to identify inefficiencies, potential failures, and performance deviations in the services(s) 108 within the client environment 104.

In some embodiments, the client environment 104 may include the user device 110, such as a laptop, a desktop, a remote computer, a tablet, or a smartphone. In some examples, the user device 110 may be a user device of an employee, say, an admin personnel who is entrusted with the management and controlling of the service(s) 108 in the client environment 104. In some embodiments, the admin personnel may communicate with the system 102 for performing an impact analysis associated with the service outage of the service in the client environment 104.

In an embodiment, the service outage may be understood as a failure, disruption, underperformance, or unavailability of any one of the service(s) 108 in the client environment 104. In an example, the service outage may be caused due to hardware malfunctions, network failures, software errors, cyberattacks, or power disruptions. For example, in case of the client environment 104 being a manufacturing plant, the production line system may be a service 108 responsible for ensuring conveyor belts and robotic arms are functioning correctly. In an embodiment, the service outage of the production line system may occur due to factors such as sensor malfunctions, power failures, or software errors in the automation system. In an example, if the production line system experiences an outage, conveyor belts may stop functioning, robotic arms may fail to assemble components, and raw materials may not move through different production stages. As a result, the manufacturing plant may face operational delays, accumulation of unfinished products, and financial losses due to missed production targets. The monitoring system 106 may detect the outage by identifying anomalies in conveyor belt speed or detecting inactivity in robotic arms, triggering alerts for corrective actions. Further, in an example, in case of the client environment 104 being an industry, the network and communication service may be a service 108 responsible for handling internet connectivity, data transfer, and cloud operations. In said example, a service outage of the network and communication service may occur due to network congestion, server failures, or cybersecurity attacks.

Further in an embodiment, the impact analysis may be understood as the process of evaluating the effects of a service outage of at least one of the services(s) 108 in the client environment 104. In an example, impact analysis may include, but is not limited to, assessing the extent of operational disruption, identifying affected components, determining financial and productivity losses, in relation to the service facing the service outage. In an embodiment, the impact analysis may be business and financial consequences of the operational disruptions in the service(s) 108. In an example, the impact analysis may be performed by one or more operations performed by the system 102 which is in communication with the client environment 104. Details of the one or more operation performed by the system 102 may be explained later in the detailed description.

In an embodiment, the system 102 may be implemented locally at a site of the client environment 104 or may be implemented remotely in some embodiments. In some embodiments, the system 102 may be implemented by a service provider providing solutions related to performing impact analysis services. Herein, the system 102 may be implemented as a cloud server and/or a cloud service and/or as per a Software as a Service (SaaS) model. In said embodiments, subscription or license to the services offered by the service provider may be taken by the client environment 104 which may be a product manufacturing plants, oil and gas refinery, power generation plant, retail and e-commerce warehouse, telecommunications network, etc., for performing impact analysis associated with the service outage of the service(s) of said client environment 104.

In some embodiments, the system 102 may be deployed in the client environment 104 as an on-premises solution, where the system 102 is implemented and operated locally within the product manufacturing company's infrastructure. In another example, the system 102 may be deployed as a cloud-based solution. In yet another example, the system 102 may be deployed as a hybrid solution, combining on-premises and cloud-based components. As mentioned above, the system 102 may be implemented as a solution service by a service provider to aid product manufacturing companies to efficiently carry out impact analysis associated with the service outage of the service(s) associated with said manufacturing companies. For instance, in an example, a service outage may occur in one of the services(s) 108 in a manufacturing plant. In an embodiment, said service outage may be reported to the system 102 by the monitoring system 106 which is monitoring the services 108 in the manufacturing plant.

According to embodiments of the present subject matter, the system 102 may be configured to utilize data associated with the service(s) 108 of the manufacturing plant and historical records associated with the service(s) 108 of the manufacturing plant to perform the impact analysis associated with the service outage of said service 108. In an embodiment, the system 102 may utilize data which include service description of the service(s) 108. Details of data associated with the service(s) 108 and the historical records associated with the service(s) 108 may be explained later in the detailed description. In an example, data associated with the service(s) 108 of the manufacturing plant and historical records associated with the service(s) 108 may be available with the system 102. In an example, said data may be provided by the client environment 104 while taking the subscription of the system 102 from the service provider. For example, the manufacturing plant may subscribe to the services of the system 102 and may utilize the same in order to perform impact analysis associated with a service outage caused due to a power failure in the manufacturing plant.

In operation, on the occurrence of a service outage in a service of the manufacturing plant, the system 102 may receive an alert message from the client environment 104. In an example, the alert message may serve as a notification that the service outage has occurred in at least one of the service(s) 108. In an embodiment, the alert message received by the system 102 from the client environment 104 may include details regarding the service outage, which may be used by the system 102 to perform impact analysis caused due to said service outage.

In an example, the alert message may include service identifier to identify the specific service 108 that has experienced an outage. For example, in a manufacturing plant, the alert message may indicate that the affected service is Network_Service_03 or Conveyor_Belt_02, allowing the system 102 to pinpoint the impacted service. Further, the alert message may include timestamp to specify the exact time at which the service outage occurred. For example, the alert message may indicate that Conveyor_Belt_02 stopped functioning at 14:35:20 on 12 Feb. 2025. Further, the alert message may include outage severity to indicate the severity level of the outage based on predefined thresholds. In an example, the severity may be classified as Critical, Major, or Minor. For instance, a critical outage may imply a complete halt in production, while a minor outage may indicate a temporary slowdown in operations. Further, the alert message may further include error codes. If applicable, the alert message may include system-generated error codes that provide diagnostic insights. For example, an alert related to database connectivity issues may contain the error code E502: Database Connection Lost, allowing the system 102 to determine the nature of the problem. Further, the alert message may further include affected components. The alert message may list the subsystems or equipment impacted by the outage. In an example, if the network service fails in a telecommunications client environment 104, the alert message may specify that Server Cluster A is affected. Similarly, in a manufacturing plant, the alert may indicate that Production Line B has stopped due to a conveyor belt failure.

Further, the alert message may further include root cause indicators. The alert message may suggest a probable cause for the outage, if available. In an example, the message may include indicators such as Power Surge Detected or Software Malfunction Identified. These indicators assist the system 102 in identifying potential reasons for the service outage. Further, the alert message may include additional user annotations, particularly when manually reported using the user device 110. For example, in a factory environment, the admin personnel may enter a note stating Factory cooling system shut down due to circuit failure, providing supplementary information that might not be automatically detected by the monitoring system 106.

In an example, the alert messages generated by monitoring system 106 may be pushed to the system 102 using a dedicated message broker or through a direct database query. In an example, the message broker may be instant notifications like a instant messaging application message, a text message, and an email. Further, in an example, the database query may be periodic check-in by the system 102 which include reading data related to service(s) 108 at regular intervals. Further, in an example, the client environment 104 may communicate with the system via secure APIs or IoT gateways. The client environment 104 may transmit alerts and operational data to the system 102 over the internet.

In an embodiment, upon receiving the alert message from the client environment 104, the system 102 may initiate a retrieval process based on this alert message for gathering information required for performing the impact analysis. Herein, the system 102 may obtain: (a) one or more description documents associated with the service 108 and (b) one or more historical case reports that document previous instances of similar service outages within the client environment 104. In an embodiment, the documents and reports may be stored in one or more data storages of the system 102, which may include structured databases, cloud repositories, or on-premises storage systems. Accordingly, the system 102 may access these storages for obtaining the documents and the reports.

In an example, the description documents may include one or more of technical specifications, operational workflows, dependency mappings, failover and recovery mechanisms, throughput details, performance thresholds, security and compliance requirements, and standard operating procedures (SOPs) related to the service 108 of the client environment 104. For instance, the service may be a network communication system in an industrial facility. Accordingly, the description document associated with the network communication system service may include an outline of the network topology of the communication system, bandwidth allocation, firewall rules, and failover mechanisms. As mentioned above, this description document may be called upon by the system 102 in the event the network communication service faces a service outage and an alert related thereto is received at the system 102.

Further, in an example, the historical case reports may include past incident records, failure logs, root cause analyses, recovery actions, and business impact assessments of previous service outages within the client environment 104 which correlate or match with the service outage going on with the service. For example, if a power outage previously disrupted the refrigeration system of a food processing plant, the corresponding historical case report may include data on the duration of the outage, temperature deviations recorded in the cold storage units, estimated product spoilage losses, and corrective measures such as generator backup activation. In further example, if an assembly line malfunctioned due to a robotic arm software failure, the historical case report may document the error codes encountered, the time taken for software patch deployment, the financial impact of production delays, and any recommendations for improving system resilience.

Based on the retrieved description document and historical case reports, the system 102 may generate an impact analysis report that provides insights related to the business impact of the service outage. In an embodiment, the system may use AI models to process the retrieved data to assess key impact factors such as estimated downtime, affected production capacity, financial losses, operational bottlenecks, and potential risk mitigation strategies. In an example, the AI models may utilize techniques and algorithms such as predictive analytics, pattern recognition, and statistical comparisons with past incidents to provide insights into the severity and long-term effects of the outage. In an example, the impact analysis report generated by the system 102 may provide information, such as the financial impact of the service outage. The impact analysis report may further provide possible solutions to mitigate the impact. In an example, impact analysis report may include revenue loss due to downtime, additional operational costs incurred, and potential penalties for missed production targets, etc.

For example, in case of an outage in a semiconductor manufacturing facility where an air filtration system has failed, the system 102 may analyse data from prior occurrences of similar failures, predicting contamination risks, yield reductions, and potential regulatory compliance issues. The impact analysis report generated by the system 102 may include estimated financial losses due to product defects, recommended maintenance schedules to prevent recurring failures, and alternative measures such as activating backup filtration systems.

In an embodiment, the impact analysis report generated by the system 102 may be presented through various formats depending on the client environment 104 and the requirements of the admin personnel. In an example, apart from displaying the report on the user device 110, the system 102 may transmit the impact analysis report as an email notification or a system-generated alert to relevant stakeholders such as operations managers, maintenance teams, or executive personnel. For instance, in case of a production line failure in an automobile manufacturing facility, the system 102 may generate an email containing a report that summarizes the affected assembly units, estimated financial impact, and required maintenance actions. Further, in an example, the system 102 may integrate the impact analysis report into an enterprise dashboard utilized by the client environment 104, wherein said report may include key impact metrics such as estimated downtime, cost implications, and affected components, presented using real-time graphs, trend analysis, and interactive charts. For example, in a data center, in case of a cooling system failure, the system 102 may generate a report which may be displayed on an infrastructure monitoring dashboard highlighting temperature variations and server downtime predictions.

Further, in an example, the impact analysis report may be generated as a downloadable or printable document such as a PDF report, wherein said report may include detailed findings, visual representations, and recommendations. For instance, in a pharmaceutical production facility experiencing a temperature deviation in its cold storage unit, the system 102 may generate a PDF report outlining compliance risks, loss estimates, and corrective actions.

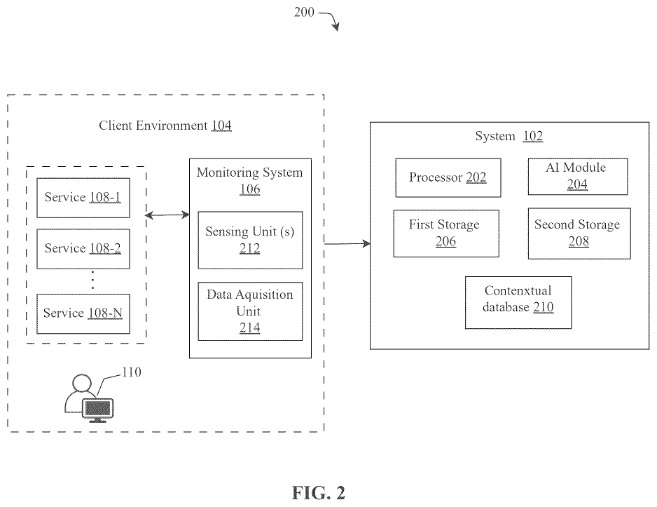

In further example, the system 102 may transmit the impact analysis data to an external enterprise resource planning (ERP) system or an incident management system utilized by the client environment 104. For instance, in an e-commerce warehouse, in case of an automated inventory tracking system failure, the system 102 may generate an impact report which may be directly logged into the ERP system of the warehouse, wherein said impact report may be accessed by the logistics and inventory teams to analyze outage details and initiate corrective actions. Further, in an example, the system 102 may provide the impact analysis report through an AI-driven voice assistant or chatbot, wherein the admin personnel of the client environment 104 may query the system 102 via a chatbot interface to receive an immediate spoken summary of the service outage impact and recommended recovery measures. Further, one or more features or components of system 102, along with their respective operations for performing impact analysis related to the service outage in the client environment 104, is provided in the detailed description of FIG. 2.

FIG. 2 illustrates a block diagram 200 of the system 102 for performing impact analysis associated with a service outage of a service in a client environment, according to one or more embodiments of the present disclosure. In some embodiments, the system 102 includes a processor 202, an AI module 204, a first storage 206, a second storage 208, and a contextual database 210. To facilitate performing of the impact analysis, the system 102 may be coupled to the client environment 104, which includes a plurality of services, referred to as service(s) 108, and the monitoring system 106. The monitoring system 106 may include a plurality of sensing units, which may be referred to as sensing unit(s) 212, and a data acquisition unit 214.

The processor 202, in some examples, may be implemented or realized as a general-purpose processor, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 202 may be realized as a combination of computing devices, such as, a combination of digital signal processors and microprocessors, a plurality of microprocessors, one or more microprocessors in conjunction with a digital signal processor core, or any other such combination/configuration. In some embodiments, one or more processors, such as the processor 104 or equivalents thereof, may be provided for performing operations thereof, as described herein.

In an embodiment, the AI module 204 may be understood as a routine or service or program implementing one or more trained models. Herein, the AI module 204 may be configured to implement one or more AI techniques using one or more trained models for processing data associated with the service(s) 108 of the client environment 104 and historical records associated with the service(s) 108 of the the client environment 104 which is provided as an input to the AI module 204. Accordingly, by application of the one or more AI techniques on said data, the AI module 204 may generate an impact analysis report and said report is provided to a user device of the client environment, such as the client environment 104, in conjunction with which the AI module 204 is implemented.

In some embodiments, the AI module 204 may be implemented on one or more processors, such as the processor 202 described above. In some embodiments, although shown distinct to the processor 202, the AI module 204 may be implemented using or as a part of the processor 202. Furthermore, any types of micro-processors, controllers, processors including graphical processing units and central processing units, routines, programs, connections, may be implemented for realizing the AI module 204. In the context of the present disclosure, without limitation, the AI module 204 may be configured process data associated with the service(s) 108 of the client environment 104 and historical records associated with the service(s) 108 of the the client environment 104 to generate the impact analysis report.

Further, in an embodiment, the first storage 206 and the second storage 208 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the first storage 206 and the second storage 208 may encompass computer-readable storage media that are distributed across a plurality of physical computing devices connected via a network, such as storage clusters within public, private, or hybrid cloud-based environments. In some embodiments, the first storage 206 and the second storage 208 may be provisioned with software components that facilitate the system 104 in executing functionalities disclosed herein. These software components typically consist of program instructions executable by the processor 202, organized into software applications, virtual machines, software development kits, toolsets, or similar structures. Furthermore, the first storage 206 and the second storage 208 may be configured to maintain data within one or more databases, file systems, or equivalent data structures. The first storage 208 and the second storage 210 may also be implemented in other forms and/or configured to store data using alternative methods. In some examples, the first storage 206 and the second storage 208 may include data associated with the service(s) 108 of the client environment 104 and historical records associated with the service(s) 108 of the the client environment 104, respectively.

Further, in an embodiment, the contextual database 210, may be referred to as a structured repository to organize and manage data in a manner that captures relationships, dependencies, and contextual relevance. Unlike conventional databases that store data in a static format, the contextual database 210 dynamically structures information based on interconnections, historical trends, and operational relevance. In an example, the contextual database 210 may enable data retrieval and processing by aligning stored information with its intended use case, to ensure that analysis and decision-making processes are driven by relevant contextual insights.

In an example, the contextual database 210 may be implemented as a search-based contextual database, such as OpenSearch or Elasticsearch, which supports efficient full-text search, indexing, and filtering mechanisms. In an example, said databases may facilitate semantic search, relevance ranking, and graph-based relationship modelling, to allow system 102 to retrieve and analyse relevant data in real time. Further, in an embodiment, the contextual database 210 may employ indexing mechanisms, machine learning-based clustering techniques, and dynamic dependency mapping to structure and retrieve data efficiently.

In an embodiment, the contextual database 210 may serve as an intelligent data repository that organizes and structures information retrieved from the first storage 208 and the second storage 210. As explained above, the first storage 208 and the second storage 210 may include data associated with the service(s) 108 of the client environment 104 and historical records associated with the service(s) 108 of the the client environment 104, respectively. The contextual database 210 processes this raw data, may arrange said data in a structured manner, and associates it with relevant metadata, such as service dependencies, failure propagation patterns, and business impact correlations. In an embodiment, based on the contextual data retrieved from the contextual database 210, system 102, including AI module 204, may analyse the service outage alert message in conjunction with relevant historical incidents and dependency structures to generate the impact analysis report. Further detailed explanations regarding the contextual database 210 and its integration with other components of system 102 are provided later in the description.

The processor 202 may be further configured to provide the contextual data retrieved from the contextual database 210 as an input to the AI module 204. The AI module 204 may be configured to generate the impact analysis report based upon said input. The processor 202 are further configured to receive the generated impact analysis report as an output from the AI module 204 for displaying on a user device 110 (not shown in the figure) present in the client environment 204.

In an example, the monitoring system 106 may oversee the service(s) 108 of the client environment by performing one or more functions which include, but are not limited to, data collection, anomaly detection and alerts, performance analysis, etc. Said one or more functions may be performed using the sensing unit(s) 212 and the data acquisition.

In an embodiment, the sensing unit(s) 212 may be configured to detect and capture real-time operational parameters of the service(s) 108 in the client environment 104. In an embodiment, the sensing unit(s) may include various types of sensors deployed across the client environment 104 to monitor physical, environmental, and performance-related conditions of the service(s) 108. In an example, the sensing unit(s) 212 may include but are not limited to temperature sensors. For example, to monitor overheating risks in case of industrial equipment, server rooms, or production lines. In an example, the sensing unit(s) 212 may include pressure sensor. For example, to detect pressure variations in hydraulic systems, pneumatic controls, and industrial pipelines. Further, in an example, the sensing unit(s) 212 may include vibration sensors. For example, to identify early signs of mechanical wear and tear in rotating machinery such as conveyor belts and robotic arms. Further, in an example, the sensing unit(s) 212 may include energy sensors. For example, to measure power consumption, voltage fluctuations, and abnormal energy usage in machines. Further, in an example, the sensing unit(s) 212 may include proximity sensors. For example, to track material movement on conveyor belts, ensuring smooth operation and detecting obstructions. Further, in an example, the sensing unit(s) 212 may include optical sensors. For example, to scan for surface defects in manufactured products, ensuring quality control. Further, in an example, the sensing unit(s) 212 may include acoustic sensors. For example, to detect abnormal noise patterns in mechanical components, which may indicate impending failures.

In an example, in case of a manufacturing plant, the sensing unit(s) 212 may be installed along production lines, near power distribution units, and on key machinery to collect operational data continuously. Further, in an example, the sensing unit(s) 212 may be capable of performing real-time condition monitoring by capturing changes in parameters and relaying them to the data acquisition unit 214. In said example, if a temperature sensor in an industrial boiler detects an increase beyond the predefined safety threshold, it may immediately trigger a signal to the monitoring system 106 to initiate corrective actions.

In an embodiment, the data acquisition unit 214 may be configured to collect, process, and transmit data captured by the sensing unit(s) 212 to the monitoring system 106. The data acquisition unit 214 may act as an interface between the physical sensing components and the computational elements of the monitoring system 106. In an example, the data acquisition unit may perform signal conditioning. For example, the raw data from the sensing unit(s) 212 may require filtering, amplification, and conversion before processing. The data acquisition unit 214 may apply signal conditioning techniques such as noise reduction, calibration adjustments, and threshold normalization. Further, in an example, the data acquisition unit may perform analog-to-digital conversion (ADC). For example, the sensing unit(s) 212 may generate analog signals that require conversion into digital format for further analysis. The data acquisition unit 214 may include ADC modules that convert real-world analog sensor readings into digital data packets. Further, in an example, the data acquisition unit may perform data aggregation. In an example, the data acquisition unit 214 may combine multiple data streams from various sensing unit(s) 212 into a structured format. In an example, in a production line system, the data acquisition unit 214 may aggregate temperature, vibration, and energy usage data from multiple sensors and create a synchronized dataset. In an example, the data acquisition unit 214 may perform timestamping and metadata tagging. For example, to ensure accurate tracking and correlation of data points, the data acquisition unit 214 may assign timestamps, sensor IDs, and contextual metadata to each recorded event. For instance, if a pressure sensor detects an anomaly in an oil pipeline, the corresponding data may include the exact timestamp, sensor location, and system status at the time of detection.

Once processed, the data may be transmitted to the monitoring system 106. In an example, the monitoring system 106 may also include processing unit (not shown in figure) for collecting the data from the data acquisition unit 214 for further processing. The processing unit may be coupled to the sensing unit(s) 212 and the data acquisition unit 214. In an embodiment, the monitoring system 214 may transmit alert messages to the system 204 when processing unit may detect predefined conditions, anomalies, or threshold breaches within the acquired data from the acquisition unit 214.

According to aspects of the present disclosure, on receiving a service outage alert message from the client environment 104, the system 102 may initiate an impact analysis to assess whether the service outage may cause any business impact on the client environment 104, utilizing various components of the system 102. To this end, the system 102 may retrieve data associated with the service(s) 108 of the client environment 104 and historical records associated with the service(s) 108 of the the client environment 104 from one or more storages present in the system 102. Based on said data and historical records of the client environment 104, the system 102's components/modules analyse the received service outage alert message and prepare/generate the impact analysis report for displaying on a user device, such as the user device 110, present in the client environment 104. Details of the operation of the system 102 is now described below.

In operation, the processor 202 may be configured to receive a service outage alert message associated with the service 108. In an embodiment, on the occurrence of the service outage in at least one of the service(s) 108 of client environment, the system 102 may receive the alert message from the client environment 104 related to said at least one of the service(s) 108. In an example, the alert message may serve as a notification that the service outage has occurred in at least one of the service(s) 108. In an embodiment, the alert message may be pushed by the monitoring system 106 to the processor 202 for performing the impact analysis associated with the service outage.

In an embodiment, on receiving the alert message related to the service 108 which is undergoing service outage, the processor 202 may obtain a service description document associated with the service 108 and may further obtain one or more historic case reports associated with the service outage from one or more data storages, such as the storages 206 and 208. In an example, the service description document may include one or more of technical specifications, operational workflows, dependency mappings, failover and recovery mechanisms, throughput details, performance thresholds, security and compliance requirements, and standard operating procedures (SOPs) related to the plurality of service(s) 108 of the client environment 104. Further, in an example, the historical case reports may include past incident records, failure logs, root cause analyses, recovery actions, and business impact assessments of previous service outages within the client environment 104 which correlate or match with the service outage going on with the service.

In an embodiment, the service description document associated with the service 108 may be stored in the first storage 206. Further, the one or more historic case reports associated with the service outage may be stored in the second storage 208. In an embodiment, to obtain the service description document associated with at least one service 108 and one or more historic case reports associated with the service outage, the processor 202 may be configured to transmit a search request to the contextual search database 210.

The search request, in an example, may be indicative of a service identifier of the service 108 and information associated with the service outage. In an example, the service identifier may be uniquely associated with the service 108. Further, the information associated with the service outage, may include error codes, timestamps, failure conditions, and impacted system components, etc. Once the required information of service identifier of the service 108 and the information associated with the service outage is collected, the processor 202 may structure the search request in a format that the contextual database 210 may understand. In an example, the format may be a structured query language (SQL) query, a REST API request, or a search query formatted using OpenSearch or Elasticsearch, depending on how the contextual database 210 is implemented. Once the search request is structured, the processor 202 may transmit it to the contextual database 210 over a communication interface, such as an internal network connection or an API gateway.

Upon receiving the search request, the contextual database 210 may first query the first storage 206. In an embodiment, the first storage 206 is a documents database comprising a plurality of service description documents corresponding to a plurality of service(s) 108. The service identifier included in the search request may allow the contextual database 210 to retrieve the specific service description document that provides details regarding the service's function, dependencies, and operational parameters. In an embodiment, the contextual database 210 may store the service description document in a structured manner by associating it with relevant metadata, dependencies, and operational context. Unlike traditional databases that store documents in static tables or isolated records, the contextual database 210 may organize the service description document in a way that allows for context-aware retrieval, semantic associations, and dependency mapping.

For example, upon retrieval of raw data, the contextual database 210 processes real-time sensor readings from the first storage 208, which may include temperature fluctuations, vibration anomalies, and power consumption metrics for a CNC machine in a manufacturing plant. The retrieved data may be structured by associating each sensor reading with relevant metadata, such as machine ID, timestamp, and predefined operational thresholds. In an example, if a CNC machine records a temperature of 85 °C, exceeding the threshold of 80 °C, and a vibration level of 12 mm/s against the standard limit of 10 mm/s, the contextual database 210 dynamically marks the event as an anomaly and establishes a dependency between the detected anomaly and the machine's historical failure patterns. Further, said service description document may be transmitted to the processor 202.

Further, in an embodiment, upon receiving the search request, the contextual database 210 may query the second data storage 208 based information associated with the service outage in the search request. In an embodiment, the second data storage 210 may be a historical reports database comprising a plurality of historic case reports corresponding to a plurality of service outages of a plurality of service(s) 108. In an embodiment, the historical reports database may serve as a centralized repository where impact analysis reports generated for past service outages are systematically stored. Each stored report contains detailed information about the nature of the outage, affected services, root causes, duration, business and financial impact, mitigation strategies applied, and resolution timelines. By maintaining a structured record of previous incidents, the historical reports database may enable the system 102 to perform comparative analysis and trend identification for more informed decision-making in future outages.

The information associated with the service outage, such as failure type, timestamp, or affected components, may be used to filter and retrieve past incidents that share similarities with the current outage in the second data storage 208. In response to the query, the one or more historic case reports associated with the service outage may be received by the contextual database 210, from the historical reports database. In an embodiment, the contextual database 210 may store the historic case reports by structuring and indexing the retrieved historical case reports to establish meaningful relationships between past incidents, service dependencies, and failure propagation patterns.

In an example, if the retrieved historical records indicate that the same CNC machine encountered overheating and excessive vibration six months ago, resulting in a four-hour downtime due to cooling system inefficiency, the contextual database 210 associates this past failure with the service outage and information indicated in the search request. By utilising dependency mapping, the contextual database 210 may identify recurring patterns, establishing correlations between overheating incidents and subsequent maintenance actions. For example, if historical case reports reveal that previous overheating events required recalibration of thermal sensors and adjustments to lubrication flow rates, the contextual database 210 contextually links these corrective actions with the ongoing service outage and information as indicated in indicated in the search request. In an embodiment, the contextual database 210 structures and indexes this information dynamically using graph-based relationship modeling. Further, said one or more historic case reports to may be transmitted to the processor 202.

In an embodiment, the processor 202 may be configured to provide the service description document, the one or more historic case reports, and at least one prompt as an input to the AI model. The at least one prompt may be either a static prompt, in an implementation and may be provided to the AI model accordingly. In other implementations, the prompt may be dynamically generated or formulated with or without user inputs, as described below.

In an embodiment, the processor 202 may be configured to display a plurality of prompts on the display of the user device 110 (not shown in the figure). In an embodiment, the plurality of prompts comprises a corresponding business impact analysis instruction. In an embodiment, a prompt refers to a structured instruction or query displayed on the user device 110 present in the client environment 104 to facilitate business impact analysis of a service outage. In an example, the plurality of prompts indicates that multiple instructions or queries are available for selection, each corresponding to a specific dimension of business impact analysis. For example, under the financial dimension, a prompt may include “Analyze financial loss impact due to downtime exceeding X hours.” Further, under the operational dimension, the processor 202 may display “Assess impact on production backlog and shipment schedules.” Further, under the maintenance dimension, the prompt may be “Identify correlation between repeated failures and maintenance cycles.”

In an example, the prompts may be displayed through a dropdown menu, where the user may select from predefined prompts such as “Analyse financial loss impact due to downtime exceeding X hours.” Further, in an example, a checkbox selection may allow multiple prompts to be chosen simultaneously, such as “Assess impact on production backlog and shipment schedules” and “Evaluate dependency of affected service on other critical operations.” Further, a text-based chat interface may dynamically suggest prompts based on detected service outage, such as “Identify correlation between repeated failures and maintenance cycles.” Further an interactive dashboard may present categorized prompts in a graphical format, displaying options like “Compare past resolution timeframes for similar failures.” In another example, voice command input may enable the user to interact with the system 104 by selecting prompts such as “Recommend predictive maintenance measures to prevent recurrence.”

In an embodiment, the at least one prompt comprises at least one instruction to perform the business impact analysis associated with the service outage based on the service description document and the one or more historic case reports. For example, a CNC machine (CNC_005) in a manufacturing plant experiences a spindle motor failure, causing a production halt. Upon receiving the service outage alert message, the contextual database 210 retrieves the service description document associated with CNC_005, detailing its function, dependencies, and operational limits. Additionally, the contextual database 210 retrieves historical case reports specifically related to past spindle motor failures of CNC_005, showing that similar breakdowns resulted in prolonged downtime and production losses. The processor 202 may display prompts on the user device 110, the user is presented with a plurality of prompts such as “Analyze financial loss impact due to downtime exceeding 3 hours.” Said prompt may be generated as the retrieved historical case reports indicate that previous spindle failures of CNC_005 led to downtime exceeding 3 hours, causing financial losses. Further, a prompt may include “Assess production backlog and delay in shipment schedules.” Said prompt may be generated as the service description document states that CNC_005 is a critical machine in the production line, and past outages led to missed delivery deadlines.

In an embodiment, the processor 202 may be configured to receive a user input indicative of a selection of said at least one prompt from the plurality of prompts provided to the user device 110 for providing to the AI module 204. In response to receiving the service description document, the one or more historic case reports, and at least one prompt from the user device 110, the AI model 204 may generate an impact analysis report comprising information about a business impact on the client environment 104 due to one or more service outage occurred in the client environment 104.

Upon receiving these inputs, the AI module 204 first processes the service description document to extract details about the functionalities, objectives, and expected outcomes of the service. Said document provides the foundational understanding of the service, enabling the AI module 204 to establish a reference point for analysis. Further, the AI module 204 may examine the historic case reports to identify past instances where similar services were deployed. By analysing the historic case reports, the AI module 204 may determine how the service performed in different scenarios, what business impacts were observed, and whether any issues or benefits were recorded. Said step may allow the AI module 204 to recognize patterns, trends, and potential risks based on historical data. In an example, the AI module 204 may employ natural language processing and machine learning techniques to extract insights from reports.

Further, the AI module 204 may then processes the user prompt received from the user device 110. Said prompt may serve as a guiding factor that directs the AI module 204 to focus on specific aspects of the analysis. For example, if the prompt pertains to financial impact, the AI module 204 may prioritize the extraction of financial metrics and cost-related data from the service description document and the historic case reports. Further, in an example, if the prompt relates to risk assessment, the AI module 204 may focus on identifying potential failures, compliance concerns, and security risks associated with the service. Using the combined information from above three features, the AI module 204 analysis the data to generate the impact analysis report. In an embodiment, the AI module 204 may perform a comparative assessment, correlating the details of the current service with historical outcomes to predict potential business impacts. The AI module 204 may quantify the effects using performance indicators and structured evaluation methods. In an example, the impact analysis report may include a detailed summary of findings, anticipated risks or losses, and strategic recommendations to overcome the impact of the anticipated risks or losses.

For example, if a CNC machine (CNC_005) in a manufacturing plant experiences a spindle motor failure, the AI model 204 may retrieve the service description document to understand CNC_005's role in production and its dependency on other systems. The historical case reports provide insights into past failures, indicating that similar spindle motor breakdowns led to an average downtime of six hours and caused financial losses due to halted production. Further, if the user selects the prompt “Analyze financial loss impact due to downtime exceeding 3 hours,” the AI model 204 may calculate the revenue loss based on the production rate and estimated downtime. If CNC_005 produces 50 units per hour, with each unit generating $500 in revenue, and the expected downtime is six hours, the AI model 204 may estimate a potential financial impact of $150,000.

In an embodiment, the processor 202 may use predefined inputs to automatically determine relevant prompts for generating the impact analysis report without manual selection from the user device 110. For example, if the downtime exceeds three hours, the processor 202 may automatically trigger the prompt “Analyze financial loss impact due to downtime exceeding 3 hours.” Further, if the affected service, such as CNC_005, may be identified as a critical production asset, the processor 202 may generate the prompt “Assess impact on production backlog and shipment schedules.”

Further, the generated impact analysis report by the AI module 204 may be provided to the processor 202 for displaying on a display of the user device 110 in the client environment 104. Said impact analysis report may enable the client environment 104 to make decisions for mitigating the business impact of the ongoing service outage.

In an embodiment, the processor 202 may be configured to store the impact analysis report in a historical reports database which comprises the plurality of historic case reports corresponding to a plurality of service outages of a plurality of service(s) 108. In the impact analysis report may be the latest generated impact analysis report and stored in the historical reports database, which maintains the repository of past case reports corresponding to various service outages across plurality of service(s) 108.

For example, consider a scenario where a cloud service provider experiences a critical outage in its authentication service, preventing users from accessing enterprise applications. Once the outage is detected, processor 202 generates an impact analysis report detailing key factors such as estimated revenue loss, affected business operations, customer complaints, and corrective measures like failover strategies or system patches. After generating the report, processor 202 stores it in the historical reports database, ensuring that it is available for future reference. If a similar authentication service outage occurs later, processor 202 can retrieve relevant historical reports from the database to analyze past incidents, evaluate their impact, and suggest mitigation strategies based on previously successful resolutions.

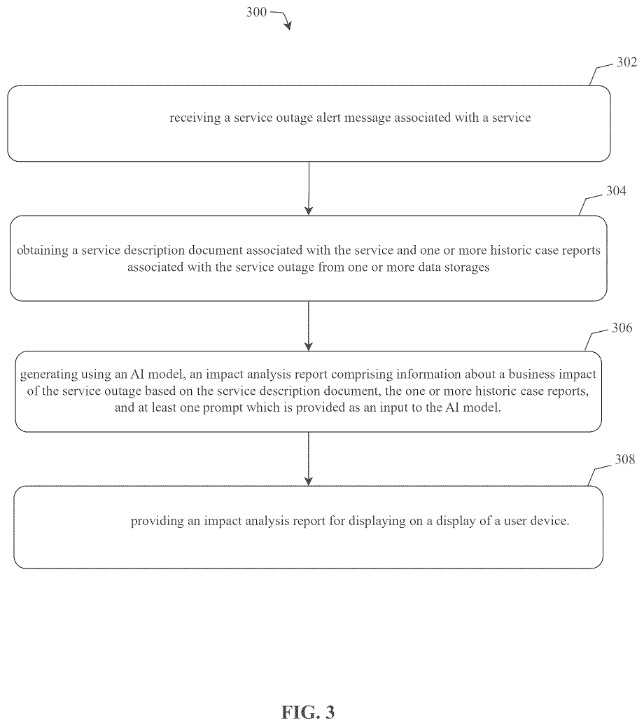

FIG. 3 illustrates a flowchart of a method for performing impact analysis associated with a service outage of a service, according to one or more embodiments of the present disclosure. In an embodiment, the service(s) 108 may refer to the various operational, technical, and functional components that ensure the execution of tasks within a client environment 104. In an example, the service(s) 108 may include, but are not limited to machine operations, data management, network communication, energy distribution, process automation, security protocols, etc. In an embodiment, the service outage may be understood as a failure, disruption, underperformance, or unavailability of any one of service(s) 108 in the client environment 104. In an example, the service outage may be caused due to hardware malfunctions, network failures, software errors, cyberattacks, or power disruptions. Further, in an embodiment, the impact analysis may be understood as the process of evaluating the effects of a service outage of at least one of the services(s) 108 in the client environment 104. In an example, impact analysis may include, but is not limited to, assessing the extent of operational disruption, identifying affected components, determining financial and productivity losses, in relation to the service facing the service outage.

For example, in the client environment 104, say a manufacturing plant, a service may refer to an automated assembly line, an industrial cooling system, or a robotic material handling system. Further, the service outage may include a failure in the assembly line due to a conveyor belt malfunction, a breakdown in the cooling system leading to overheating of machinery, or a disruption in the robotic handling system causing delays in material movement. Further, the impact analysis for such outages may be indicative of financial loss, including revenue loss due to production downtime, increased operational costs from emergency repairs or manual intervention, penalties for delayed deliveries, and potential contractual liabilities arising from supply chain disruptions.

The steps of the method 300, described in connection with the embodiments disclosed herein, may be embodied directly in hardware, in firmware, in a software module executed by a system, or in any practical combination thereof. In some embodiments, the method 300 may be implemented by the system 102 which may be deployed in the client environment 104 as an on-premises solution, where the system 102 is implemented and operated locally within the product manufacturing company's infrastructure or deployed as a cloud-based solution or deployed as a hybrid solution, combining on-premises and cloud-based components.

In an example, the method 300 may commence at step 302 when a service outage alert message associated with a service 108 is received at the system 102. In an embodiment, the service outage alert message may be received from the monitoring system 104 present in the client environment 104. Upon receiving the service outage alert message, to generate an impact analysis report, one or more steps of the method 300 may be performed.

At step 304, the method 300 includes obtaining a service description document associated with the service and one or more historic case reports associated with the service outage from one or more data storages. In an embodiment, the one or more data storages may be present in the system 102. In an embodiment, one or more data storages may include plurality of service description documents associated with the plurality of service(s) 108 and one or more historic case reports associated with said service (s)' outage. Upon receiving the alert message related to at least one service, a processor 202 may obtain service description document associated with service indicated in the alert message and one or more historic case reports associated with said service outage from amongst the plurality of service description documents and one or more historic case reports respectively. Further, the service description document associated with the service 108 and one or more historic case reports associated with the service outage may be provided by the client environment 104 to the system 102 for storing into one or more data storages. The step 304 may be performed by the processor 202, in an example.

At step 306, the method 300 may include generating the impact analysis report comprising information about a business impact of the service outage based on the service description document, the one or more historic case reports, and at least one prompt. In an embodiment, the service description document, the one or more historic case reports, and at least one prompt is provided as an input to an AI model 204. In an embodiment, the impact analysis report may be generated using the AI model 204. In an embodiment, the AI model 204 may process these inputs to generate the impact analysis report, identifying patterns and correlations based on past incidents. For example, if a cloud storage service experiences an outage, the AI model 204 may analyse prior occurrences of similar outages and determine their effect on data accessibility, business transactions, and customer interactions. The AI model 204 may further predict potential revenue losses, operational bottlenecks, and compliance risks.

In an embodiment, the at least one prompt may comprise at least one instruction to perform the business impact analysis associated with the service outage based on the service description document and the one or more historic case reports. In an example, the impact analysis report may be generated when the AI model 204, processes inputs such as the service description document, historic case reports, and at least one prompt. The prompt may serve as an instruction set, allowing the client environment 104 to specify the type of analysis required, such as financial impact, customer sentiment, or recovery time estimation. For example, in an online banking outage, the service description document details critical services affected, while historic case reports provide insights into past disruptions. The user in the client environment 104 may select a prompt provided by the method 300 such as “Estimate revenue loss based on failed transactions” or “Compare past outages to predict recovery time.” The user may select at least one of the prompts and based upon his selection, the AI model 204 may analyse relevant data and generates a report with actionable insights. In an embodiment, said step may be performed by the processor 202 and the AI module 204 in communication with the user device 110 in the client environment 104.

Further, in an example, in a logistics company experiencing a server failure that disrupts shipment tracking, the AI model 204 may be provided with the service description document, which states that the tracking system is integrated with warehouses and customer portals, the historic case reports, which show that a similar outage last year caused delays in shipments, leading to increased customer complaints and a temporary revenue dip and a prompt, such as “compare this outage with previous tracking system failures and estimate potential delivery delays and customer impact.” By processing this instruction, the AI model 204 may generate an impact analysis report highlighting expected disruptions in supply chain operations, potential financial losses, and customer service implications. The report may also suggest mitigation strategies based on how similar past incidents were resolved.

At step 308, the method 300 may include providing the impact analysis report for displaying on a display of the user device 110. In an example, the impact analysis report generated by the AI module 204 may be transmitted to the processor 202 for providing it to the client environment 104.

In an example, the impact analysis report may be provided by the processor 202 to be displayed in various formats, such as an interactive dashboard, a structured text-based report, or a notification-based alert, depending on the nature and severity of the outage. In an example, the impact analysis report may include a summary section providing an overview of the affected services and estimated downtime, a business impact analysis detailing financial, operational, and customer-related consequences, a historical comparison module that evaluates similar past incidents, and a risk assessment section that may outline recommended actions for mitigation and recovery.

For example, in an e-commerce platform experiencing a checkout system outage, the impact analysis report may be displayed as an alert indicating a critical disruption in payment processing. The impact analysis report may state that 40% of users are unable to complete transactions, leading to an estimated revenue loss of $50,000 within the first two hours. The historical comparison module may highlight that a similar outage occurred six months ago due to a server overload, which was resolved within 1.5 hours using traffic rerouting and cache optimization. The report may further provide actionable recommendations such as activating backup servers, notifying customers about service restoration progress, and increasing support team availability to manage potential complaints.

Further, in an example, the impact analysis report may use color-coded indicators to differentiate severity levels, such as red for critical outages, yellow for moderate disruptions, and green for resolved issues. Further, the impact analysis report may also include interactive elements that allow users to request additional insights, share the impact analysis report with operational teams, or trigger automated recovery protocols.

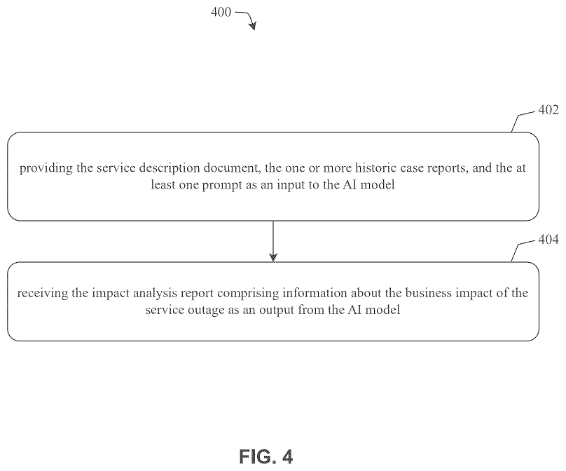

FIG. 4 is a flowchart illustrating a method for generating an impact analysis report associated with a service outage of a service, according to one or more embodiments of the present disclosure.

At step 402, for generating the impact analysis report, the processor 202 may provide the service description document, one or more historic case reports, and at least one prompt as input to the AI model 204. In an embodiment, the processor 202 may retrieve the service description document and historic case reports associated with the service outage corresponding to the service 104, as included in the service outage alert message. Further, the processor 202 may be configured to provide a structured prompt to the user in the client environment 104. Once the user selects at least one of the prompts and transmits the selected prompt to the processor 202, the processor 202 may then provide the selected prompt along with the service description document and historic case reports to the AI model 204. The at least one prompt may serve as an instruction set that directs the AI model 204 to assess the business impact by correlating the current outage with past incidents.

At step 404, the processor 202 may be receiving the impact analysis report comprising information about the business impact of the service outage as an output from the AI model 204. In an embodiment, the provided inputs may be processed by analyzing the service description document and historic case reports in conjunction with the instructions in the prompt. In an embodiment, the step may include identification of patterns, comparing the current outage with previous incidents, estimating financial losses, and suggesting the recovery strategies by the AI module 104. Once the AI model 204 generates the impact analysis report, said report may be retrieved by the processor 202 for further use, such as displaying it on a user device 110.

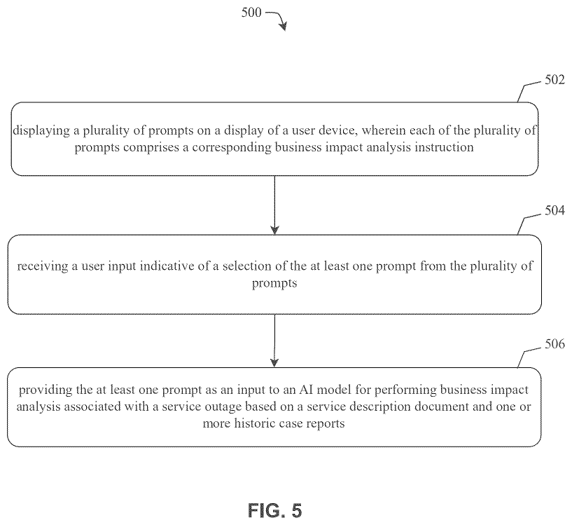

FIG. 5 is a flowchart illustrating a method for performing impact analysis associated with a service outage of a service, according to one or more embodiments of the present disclosure. The method 500 may indicate the process by which the system 102 interacts with the user in the client environment 104 to facilitate a structured business impact analysis. The method 500 may be performed by the processor 202, AI model 204, and the user device 110.

At step 502, the method 500 may include displaying a plurality of prompts on the display of the user device 110 in the client environment 104. In an example, each of the plurality of prompts comprises a corresponding business impact analysis instruction. In an embodiment and as explained earlier in the description that prompts may serve as structured instructions, allowing the user to choose the type of impact analysis they wish to perform. Each prompt corresponds to a specific business impact analysis instruction, guiding the AI model 204 to focus on particular aspects of the service outage. The plurality of prompts may be displayed in various formats, such as a dropdown menu, a list of selectable options, or an interactive dashboard on the user device 110. By presenting the plurality of prompts, the method 500 may allow the user to customize the impact analysis, ensuring that the impact analysis report generated is relevant to their specific business concerns.

Further, at step 504, the method 500 may include receiving a user input indicative of a selection of the at least one prompt from the plurality of prompts. In an embodiment, the user, who may be an employee, say, an admin personnel who is entrusted with the management and controlling of the service(s) 108 in the client environment 104 may interact with the user device 110 to select one or more prompts that align with their requirements. In an example, the selection may be made through a touchscreen interface, mouse click, or voice command. Once the user selects the desired prompt(s), the input may be transmitted to the processor 202, which then forwards the selected prompt along with relevant outage data which include the service description document and the historic case reports to the AI model 204 for processing.

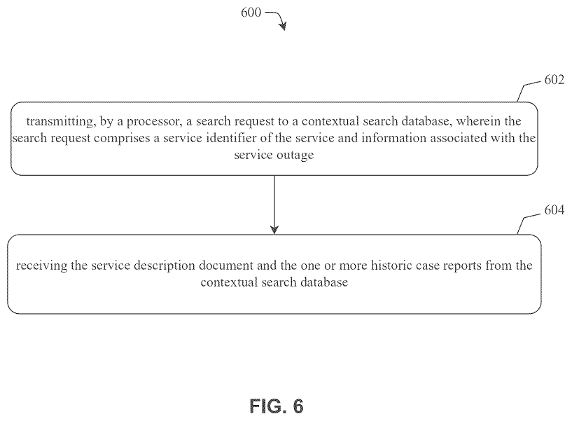

FIG. 6 is a flowchart illustrating a method for performing impact analysis associated with a service outage of a service, according to one or more embodiments of the present disclosure. At step 602, the method 600 may include transmitting a search request to a contextual search database 210. In an embodiment, the search request may be generated by the processor 202, which extracts key details about the service outage, including a service identifier and relevant outage information. The service identifier may identify the affected service, while the outage information may include error logs, timestamps, affected modules, and initial diagnostic reports, etc. The processor 202 may format above details into a structured query and transmits the search request to the contextual search database 210. In an embodiment, the contextual database 210 may be included in the system 202.

For example, in the case of a cloud storage provider experiencing a service disruption, the search request may contain service identifier as “Cloud Storage—Region A” and outage information as file access failure detected at 03:15 UTC, affecting 40% of users. By sending said search request to the contextual search database 210, the processor 202 may retrieve the information which is specific to the affected service and aligned with the current outage conditions.

At step 604, the method 600 may include receiving the service description document and the one or more historic case reports from the contextual search database 210. In an embodiment, the contextual search database 210 processes the search request received from the processor 202, extracts relevant records, and retrieves the service description document along with historic case reports that align with the current outage scenario.

In an example, if a manufacturing plant's automated assembly line experiences a failure, the contextual search database 210 may retrieve service description document which include a technical overview outlining the assembly line's operational workflow, machinery specifications, integration with robotic systems, sensor-based monitoring mechanisms, and real-time production tracking processes. Further, the contextual search database 210 may retrieve historic case reports which may include a collection of previous incidents where machinery failures, robotic arm malfunctions, or conveyor belt disruptions were recorded, including root cause analyses e.g., sensor misalignment, etc. Upon retrieval, the service description document and historic case reports may be transmitted to the processor 202, which utilizes them as input for the AI model 204.

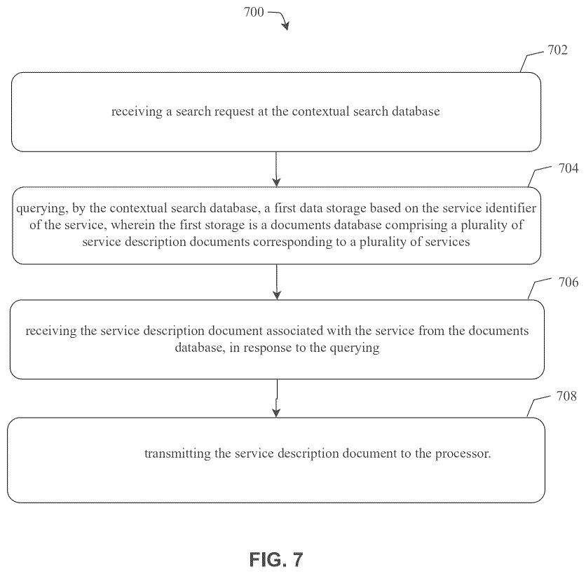

FIG. 7 is a flowchart illustrating a method for obtaining a service description document associated with a service while performing impact analysis, according to one or more embodiments of the present disclosure. At step 702, the method 700 may include receiving the search request at the contextual search database 210 which may serve as a central repository for storing structured information about multiple service(s) 108 in contextual manner. In an example, the search request may be transmitted by the processor 202.

Further, at step 704, the method 700 may include querying a first storage 206 based on the service identifier of the service by the contextual search database 210. In an embodiment, the first storage 206 is a documents database comprising a plurality of service description documents corresponding to a plurality of service(s) 108. Upon receiving the search request, the contextual search database 210 may initiate a query operation to locate the relevant service description document by matching the provided service identifier in the search request with entries stored in the first storage 206.

Further, at step 706, the method 700 may include receiving the service description document associated with the service from the documents database, in response to the querying. The first storage 206 which is the document database may retrieve the relevant service document and transmit it to the contextual search database 210. In an embodiment, rather than storing the service document in its raw format as received from the first storage 206, the contextual search database 210 may organize the received data in a contextual manner. For example, the received service description document may be indexed and linked with other related information, such as previous outages, dependencies on other systems, and impact assessment records.

Further, at step 708, the method 700 may include transmitting the service description document to the processor 202. Once the service description document is contextually arranged in the contextual database 210, said service description document may be transmitted to the processor 202. The processor 202 may then transmit said document, along with the contextual information, to the AI model 204 for further analysis.

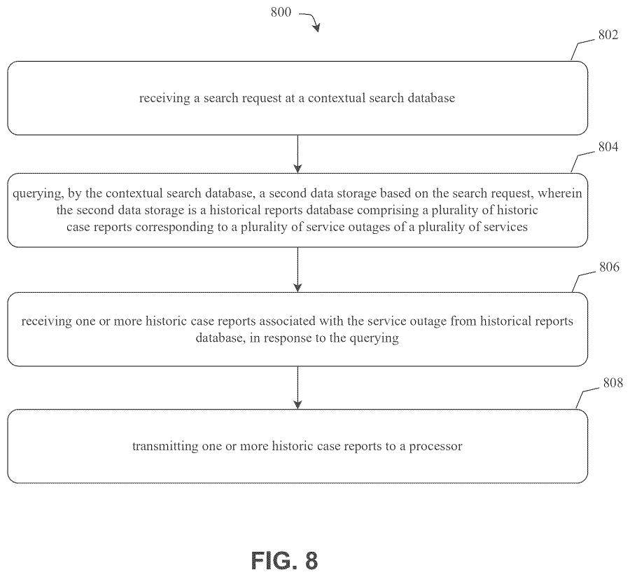

FIG. 8 is a flowchart illustrating a method for performing impact analysis associated with a service outage of a service, according to one or more embodiments of the present disclosure. At step 802, the method 800 may include receiving the search request at the contextual search database 210.

Further, at step 804, the method 800 may include querying a second data storage 208 based on the search request by the contextual search database 210. In an embodiment, the second data storage 208 may be a historical reports database comprising a plurality of historic case reports corresponding to a plurality of service outages of a plurality of services. In an example, the historical reports database may be a repository of historic case reports associated with various service outages across multiple service(s) 110. Further, historical reports database, the contextual search database 210 may organize said report in a contextual manner, meaning that each historic case report is linked to specific service identifiers, failure patterns, resolution strategies, and impact assessments.

Further, at step 806, the method 800 may include receiving the one or more historic case reports associated with the service outage from the historical reports database, in response to the querying. The second storage 210 which is the historical reports database may retrieve the one or more historic case reports and transmit it to the contextual search database 210. In an embodiment, rather than storing one or more historic case reports in their raw format as received from the second storage 210, the contextual search database 210 may organize the received data in a contextual manner.

Further, at step 808, the method 800 may include transmitting the one or more historic case reports to the processor 202. Once the the one or more historic case reports are contextually arranged in the contextual database 210, said the one or more historic case reports may be transmitted to the processor 202. The processor 202 may then transmit said one or more historic case reports, along with the contextual information, to the AI model 204 for further analysis.

The present invention enhances the efficiency and accuracy of impact analysis for service outages by providing a structured and automated approach to assessing business and financial consequences. The system and method eliminate the delays and uncertainties associated with manual evaluations, enabling organizations to make faster, data-driven decisions during critical incidents. By improving the visibility of potential risks and operational disruptions, the invention helps businesses develop effective mitigation strategies, reducing financial losses and safeguarding business continuity.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary

What is claimed is:

1. A method of performing impact analysis associated with a service outage of a service, the method comprising:
receiving a service outage alert message associated with the service;
obtaining a service description document associated with the service and one or more historic case reports associated with the service outage from one or more data storages;
generating using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports; and
providing the impact analysis report for displaying on a display of a user device.

2. The method as claimed in claim 1, wherein the step of generating further comprises:
providing the service description document, the one or more historic case reports, and the at least one prompt as an input to the AI model; and
receiving the impact analysis report comprising information about the business impact of the service outage as an output from the AI model.

3. The method as claimed in claim 1, wherein the method further comprises:
displaying a plurality of prompts on the display of the user device, wherein each of the plurality of prompts comprises a corresponding business impact analysis instruction;
receiving a user input indicative of a selection of the at least one prompt from the plurality of prompts; and
providing the at least one prompt as an input to the AI model for performing the business impact analysis associated with the service outage based on the service description document and the one or more historic case reports.

4. The method as claimed in claim 1, wherein the step of obtaining further comprises:
transmitting, by a processor, a search request to a contextual search database, wherein the search request comprises a service identifier of the service and information associated with the service outage; and
receiving the service description document and the one or more historic case reports from the contextual search database.

5. The method as claimed in claim 4, wherein the method further comprises:
receiving the search request at the contextual search database;
querying, by the contextual search database, a first data storage based on the service identifier of the service, wherein the first storage is a documents database comprising a plurality of service description documents corresponding to a plurality of services;
receiving the service description document associated with the service from the documents database, in response to the querying; and
transmitting the service description document to the processor.

6. The method as claimed in claim 4, wherein the method further comprises:
receiving the search request at the contextual search database;
querying, by the contextual search database, a second data storage based on the search request, wherein the second data storage is a historical reports database comprising a plurality of historic case reports corresponding to a plurality of service outages of a plurality of services;
receiving the one or more historic case reports associated with the service outage from the historical reports database, in response to the querying; and
transmitting the one or more historic case reports to the processor.

7. The method as claimed in claim 1, wherein the method further comprises storing the impact analysis report in a historical reports database which comprises a plurality of historic case reports corresponding to a plurality of service outages of a plurality of services.

8. A system for performing impact analysis associated with a service outage of a service, the system comprising:
a storage; and
at least one processor coupled to the storage, the at least one processor configured to:
receive a service outage alert message associated with the service;
obtain a service description document associated with the service and one or more historic case reports associated with the service outage from one or more data storages;
generate using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports; and
provide the impact analysis report for displaying on a display of a user device.

9. The system of claim 8, wherein the at least one processor is configured to:
provide the service description document, the one or more historic case reports, and the at least one prompt as an input to the AI model; and
receive the impact analysis report comprising information about the business impact of the service outage as an output from the AI model.

10. The system of claim 8, wherein the at least one processor is configured to:
display a plurality of prompts on the display of the user device, wherein each of the plurality of prompts comprises a corresponding business impact analysis instruction;
receive a user input indicative of a selection of the at least one prompt from the plurality of prompts; and
provide the at least one prompt as an input to the AI model for performing the business impact analysis associated with the service outage based on the service description document and the one or more historic case reports.

11. The system of claim 8, wherein the at least one processor is configured to:
transmit a search request to a contextual search database, wherein the search request comprises a service identifier of the service and information associated with the service outage; and
receive the service description document and the one or more historic case reports from the contextual search database.

12. The system of claim 11, wherein the at least one contextual data base is configured to:
receive the search request;
query a first data storage based on the service identifier of the service, wherein the first storage is a documents database comprising a plurality of service description documents corresponding to a plurality of services;
receive the service description document associated with the service from the documents database, in response to the querying; and
transmit the service description document to the processor.

13. The system of claim 11, wherein the at least one contextual data base is configured to:
receive the search request;
query a second data storage based on the search request, wherein the second data storage is a historical reports database comprising a plurality of historic case reports corresponding to a plurality of service outages of a plurality of services;
receive the one or more historic case reports associated with the service outage from the historical reports database, in response to the querying; and
transmit the one or more historic case reports to the processor.

14. The system of claim 8, wherein the at least one processor is configured to:
store the impact analysis report in a historical reports database which comprises a plurality of historic case reports corresponding to a plurality of service outages of a plurality of services.

15. A computer-readable medium having computer-executable instructions stored thereon that, when executed by a processor, cause the processor to:
receive a service outage alert message associated with the service;
obtain a service description document associated with the service and one or more historic case reports associated with the service outage from one or more data storages;
generate using an AI model, an impact analysis report comprising information about a business impact of the service outage based on the service description document, the one or more historic case reports, and at least one prompt which is provided as an input to the AI model, wherein the at least one prompt comprises at least one instruction to perform the business impact analysis associated with the service outage based on the service description document and the one or more historic case reports; and
provide the impact analysis report for displaying on a display of a user device.

16. The computer-readable medium of claim 15, wherein the computer-executable instructions cause the processor to:
provide the service description document, the one or more historic case reports, and the at least one prompt as an input to the AI model; and
receive the impact analysis report comprising information about the business impact of the service outage as an output from the AI model.

17. The computer-readable medium of claim 15, wherein the computer-executable instructions cause the processor to:
display a plurality of prompts on the display of the user device, wherein each of the plurality of prompts comprises a corresponding business impact analysis instruction;
receive a user input indicative of a selection of the at least one prompt from the plurality of prompts; and
provide the at least one prompt as an input to the AI model for performing the business impact analysis associated with the service outage based on the service description document and the one or more historic case reports.

18. The computer-readable medium of claim 15, wherein the computer-executable instructions cause the processor to:
transmit a search request to a contextual search database, wherein the search request comprises a service identifier of the service and information associated with the service outage; and
receive the service description document and the one or more historic case reports from the contextual search database.

19. The computer-readable medium of claim 18, wherein the computer-executable instructions cause the at least one contextual database to:
receive the search request at the contextual search database;
query a first data storage based on the service identifier of the service, wherein the first storage is a documents database comprising a plurality of service description documents corresponding to a plurality of services;
receive the service description document associated with the service from the documents database, in response to the querying; and
transmit the service description document to the processor.

20. The computer-readable medium of claim 18, wherein the computer-executable instructions cause the at least one contextual database to:
receive the search request at the contextual search database;
query a second data storage based on the search request, wherein the second data storage is a historical reports database comprising a plurality of historic case reports corresponding to a plurality of service outages of a plurality of services;
receive the one or more historic case reports associated with the service outage from the historical reports database, in response to the querying; and
transmit the one or more historic case reports to the processor.
